(19) United States
(12) Patent Application Publication
(10) Pub. No.: US 2011/0181386 A1
(43) Pub. Date: Jul. 28, 2011

(54) Providing Guidance During Operation of a Universal Remote Control

(75) Inventors: Noel Lee, Las Vegas, NV (US); Elbert Hsiang Lee, San Francisco, CA (US); Kendrew Lee, Tsing Yi (HK); Anthony Di Chiro, Chatsworth, CA (US)

(73) Assignee: Monster Cable Products, Inc., Brisbane, CA (US)

(21) Appl. No.: 12/964,689

(22) Filed: Dec. 9, 2010

Related U.S. Application Data
(60) Provisional application No. 61/285,462, filed on Dec. 10, 2009.

(51) Int. Cl. G05B 19/02

(52) U.S. Cl. 340/4.3

(57) ABSTRACT

A system and method for providing guidance to a user of a universal remote control is described. In some cases, a backlight color remote is provided to indicate the mode of operation of a universal remote control console. In some cases, the remote control console powers down a successfully connected new electronic device during a learning mode of the remote control.

### CROSS REFERENCE TO RELATED APPLICATIONS

This application claims priority to U.S. Provisional Patent Application No. 61/285,462, filed on Dec. 10, 2009, entitled REMOTE CONTROL CONSOLE, which is hereby incorporated by reference in its entirety.

### BACKGROUND

Universal remote controls enable users of audiovisual equipment and devices (e.g., various components of a home theater) to control multiple devices using a single, universal, remote control. For example, a universal remote control may operate in one mode to send commands to a television, may operate in another mode to control a stereo, may operate in yet another mode to control lighting, and so on.

Such remote controls are also often universal in the frustration they cause users when setting up connections to new equipment, learning commands from other remote controls, guiding users within specific modes of operation, and other difficulties.

The need exists for a remote control and method of operating a remote control that overcomes these problems and progresses the state of the art, as well as one that provides additional benefits.

### BRIEF DESCRIPTION OF THE DRAWINGS

FIG. 1 is a schematic view of a remote control console.

FIG. 2 is a block diagram illustrating circuit components of a remote control.

FIG. 3 is a flow diagram illustrating a routine for backlighting components of a remote control console.

FIG. 4 is a flow diagram illustrating a routine for verifying a learning function of a remote control console.

### DETAILED DESCRIPTION

The present invention is a system and method for providing operational guidance of a universal remote control console is described. In some embodiments, a remote control console emits a backlight on housing components (e.g., a keypad) with a color specific or indicative of a certain mode of operation. The different backlight colors may assist a user of the console in remembering a current mode of the console, among other benefits. For example, the backlight may emit a blue color when the remote control console is controlling broadcasting equipment (e.g., a cable box for a television) and may emit an amber color when the remote control console is controlling recorded media equipment (e.g., a DVD player).

In some embodiments of the present invention, a remote control console, during a learning mode of operation, successfully connects to new equipment using commands or infrared codes learned or received from a third party remote control (e.g., the remote control that originally came with the equipment), and in response to a successful connection, powers down or otherwise causes the equipment to perform a function. The powering down or causing performance of a function indicates to a user the successful learning of the commands or codes of the new piece of equipment, among other benefits. For example, in response to receiving codes from a remote control associated with a stereo new to the console, the console attempts to connect to the stereo, and upon successful connection, shuts off the power to the stereo.

The following description provides specific details for a thorough understanding of, and enabling description for, various examples of the technology of the present invention. One skilled in the art will understand that the technology may be practiced without many of these details. In some instances, well-known structures and functions have not been shown or described in detail to avoid unnecessarily obscuring the description of the examples of the technology. It is intended that the terminology used in the description presented below be interpreted in its broadest reasonable manner, even though it is being used in conjunction with a detailed description of certain examples and features of the technology. Although certain terms may be emphasized below, any terminology intended to be interpreted in any restricted manner will be overtly and specifically defined as such in this Detailed Description section.

### Suitable System

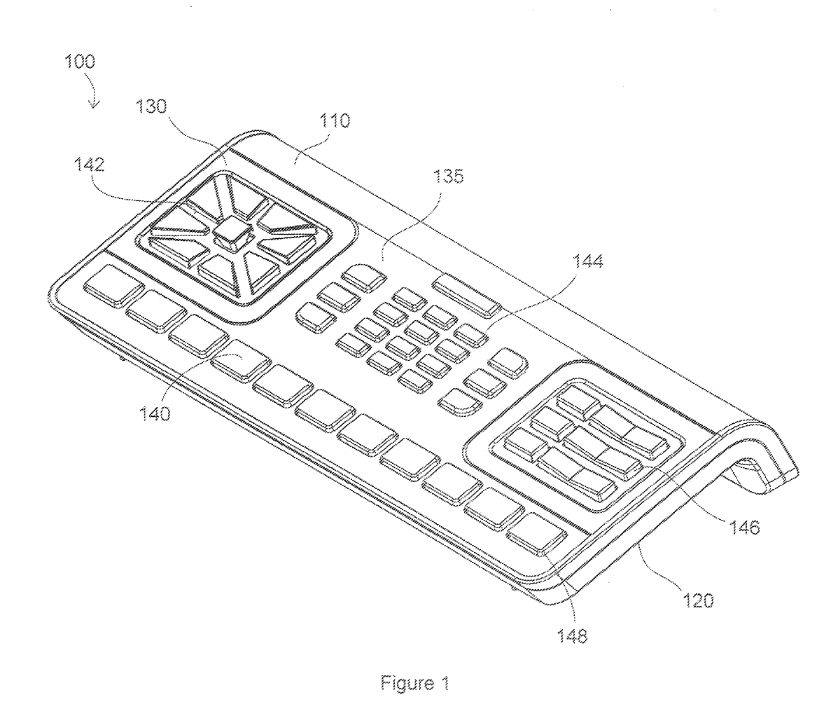

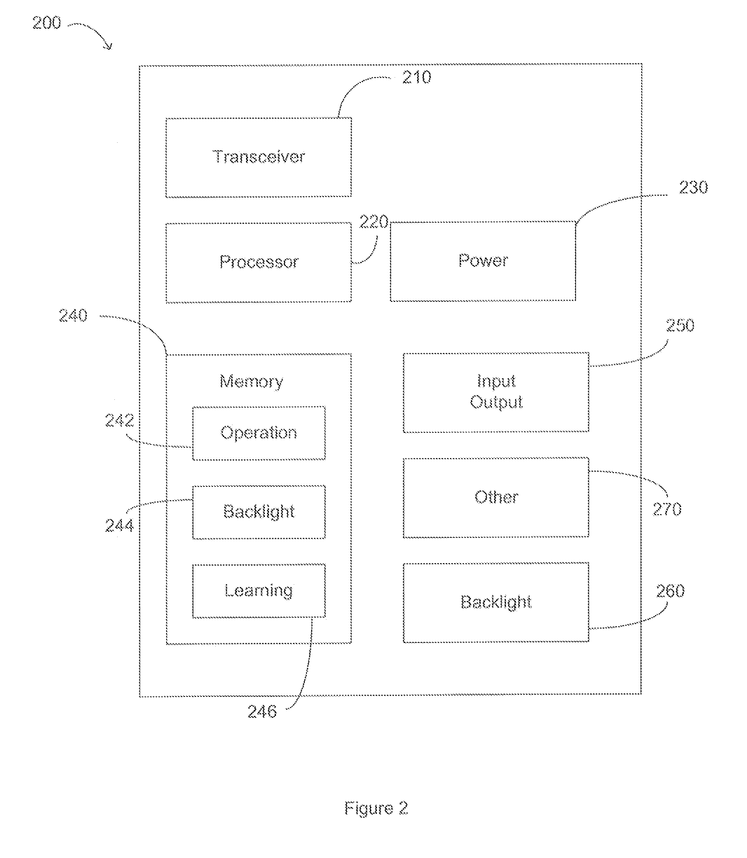

FIGS. 1 and 2 and the following discussion provide a brief, general description of a suitable remote control and device computing environment in which the system can be implemented. Although not required, aspects of the system are described as computer-executable instructions, such as routines executed by a general-purpose data processor, such as a microcontroller.

Aspects of the system can be embodied in hardware, firmware, and/or software, including components specifically programmed, configured, or constructed to perform one or more of the computer-executable instructions explained in detail herein. Similarly, some aspects of the - system may be stored or distributed on tangible computer-readable media, including magnetically or optically readable computer discs, hard-wired or preprogrammed chips (e.g., EEPROM semiconductor chips), flash memory, ROM, RAM, nanotechnology memory, biological memory, or other data storage media.

FIG. 1 is a perspective view of remote control console 100 according to the present invention, for use as a universal remote control capable of operating in different modes to provide control of various different electronic devices, appliances, and equipment. The console 100 includes a housing 110 that contains electronic circuitry (not shown) utilized to provide the functionality of the console 100. The housing 110 includes a bottom portion 120 and a top portion 130 having a top face 135. The top face 135 contains various input components 140, such as a joystick 142 or other inertial controllers, a keypad 144, rocker buttons 146, buttons 148, and/or others input components that facilitate reception of commands (e.g., raise or lower volume, start a video, change a channel, order a movie, and so on) for an associated piece of audiovisual equipment. In some embodiments, the input components 140 are formed of a number of different materials that enable a backlight to illuminate the input components 140, and, possibly, other sections of the top face 135 of the housing 110 of the console 100.

FIG. 2 is a block diagram illustrating circuit components 200 for use in a universal remote control capable of operating in multiple modes. Remote control components 200 may be incorporated into housing 110 to form remote control console 100 of FIG. 1, or may take other forms, such as a touch screen control, a control embodied by a mobile device (e.g., a smart phone running an application that provides remote control capabilities), and so on. The remote control components 200 includes a transceiver 210, such as an infrared (IR) transmitter/receiver, configured to send control signals, generally in the form of IR codes, to electronic devices and appliances controlled by the remote control 200. For example, the transceiver 210 may employ a near infrared diode, or other light emitting diode, when sending control signals to devices.

The remote control components 200 include a processor 220 configured to receive and process input received by various input or output components 250, such as the input components 140 of FIG. 1), or instructions stored in memory 240 of the remote control 200, and a power component 230, such as a battery, configured to power the processor 220, transceiver 210, and/or other components of the remote control 200. Furthermore, the remote control components 200 include a backlight component 260 configured to illuminate various portions of a housing of the remote control components 200, such as the input components 140 of the remote control console 100 of FIG. 1, and other components, such as other communication components (Wi-Fi, Bluetooth, and so on), touch screens, and so on.

The remote control components 200 include various components stored in the memory 240, such as an operation component 242 configured to provide instructions and store data for operation of the remote control 200. For example, the operation component 242 may store codes associated with various control functions performed by the remote control 200. The memory 244 also includes a backlight control component 244, configured to perform various routines and store data associated with controlling the backlight component 260 based on the mode of operation of the remote control 200, and/or a learning function component 246, configured to perform various routines and store data associated with providing indications (e.g., powering down electronic devices) in response to the successful learning of control codes. Further details regarding these components will now be discussed.

### Backlighting a Remote Control Based on the Operational Mode

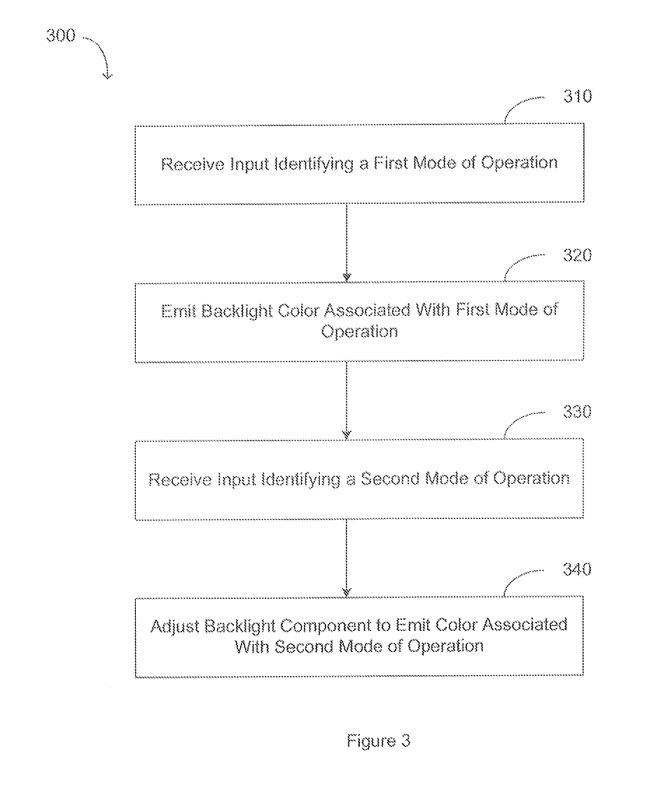

As described herein, in some embodiments, a remote control emits a backlight on housing components with a color specific or indicative of a certain mode of operation. FIG. 3 is a flow diagram illustrating a routine 300 for backlighting components of a remote control console. In step 310, a remote control receives input indicating a first mode of operation. For example, the console 100 receives, via joystick 142, input from a user to control a specific electronic device, such as a television. In step 320, the remote control emits a backlight color associated with the first mode of operation. For example, the backlight control component 244 reviews a table stored in memory 240 that relates backlight colors to modes of operation, and instructs the backlight component 260 to emit a color associated with the specific electronic device, such as blue for the television.

In step 330, the remote control receives additional input identifying a second mode of operation. For example, the console 100 receives, via joystick 142, input from the user to control a different electronic device, such as a DVD player. In step 340, the remote control emits a color associated with the second mode of operation. For example, the backlight control component 244 reviews the table stored in memory 240 that relates backlight colors to modes of operation, and instructs the backlight component 260 to emit the color associated with the newly requested device, such as amber for the DVD player.

The remote control may associate colors with specific devices controlled by the remote control in a one to one fashion, or may associated colors with certain types or class of devices. For example, the remote control may emit blue colored backlight when the remote control is controlling broadcasting equipment (e.g., a cable box for a television) and may emit amber colored backlight when the remote control console is controlling recorded media equipment (e.g., a DVR player).

In some embodiments, the remote control enables user-assigned colors to operational modes. The remote control may facilitate user selection that assigns a specific color to a specific mode of operation or functionality.

In some embodiments, the remote control may selectively illuminate certain input components based on the mode of operation. For example, the remote control may only illuminate input components utilized by a user during a certain mode of operation with an associated backlight color, or may illuminate input components utilized during all modes of operation with a specific backlight color. Thus, in some cases, a first set of input components may be backlit with a first color associated with a current mode of operation of the remote control, while a second set of components (e.g., “punch through” components) may be backlit with a second color associated with all modes of operation of the remote control.

In some embodiments, the remote control may provide a backlight color based on a specific functionality within a mode of operation. For example,' many cable boxes provide broadcast television functionality as well as recorded television functionality, and the remote control may emit a backlight color based on the specific functionality, even though the mode of operation (i.e., controlling a cable box), does not change.

Thus, by modifying the backlight colors to be indicative of a mode of operation of a remote control, the system provides users with a clear indication of the operating mode of the remote control, among other benefits.

### Verifying Successful Learning of an Electronic Device

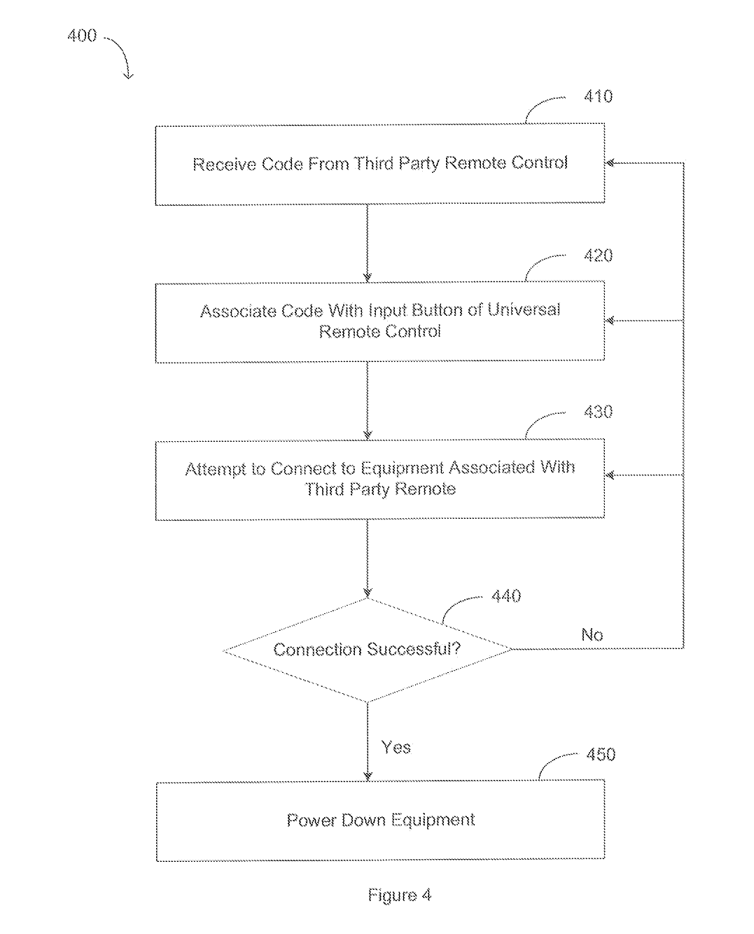

As described herein, in some embodiments, remote control console 100 in a learning mode of operation successfully connects to new equipment and provides an indication of the successful connection by powering down or otherwise causing the new equipment to perform a function indicative of the successful connection. For example, in response to receiving codes from a remote control associated with a stereo new to the console, the console attempts to connect to the stereo, and upon successful connection, shuts off the power to the stereo. FIG. 4 is a flow diagram illustrating a routine 400 for verifying a learning function of a remote control console.

In step 410, remote control console 100 receives configuration data from a third party remote control associated with a new or unknown electronic device. For example, during a learning operation mode of the remote control console 100, the learning function component 246 receives an infrared signal containing infrared codes from a remote control associated with an electronic device to be added to the remote control.

In step 420, the remote control associates the received code with an input component of the remote control. For example, the learning function component 246 associates the code with a button that carries out a command represented by the code. In step 430, the remote control attempts to connect to the new electronic device. For example, the learning function component 246 causes the transceiver 210 to transmit a signal to the new electronic device.

In step 440, the remote control determines if the connection was successful. If the connection was not successful, routine 400 returns to any one of the preceding blocks to restart the learning function. If the connect was successful, routine 400 proceeds to step 450, and the remote control powers down the new electronic device. For example, the transceiver 210 may receive a signal back from the new electronic device, and the learning function component 246 validates the connection as successful and causes the transceiver 210 to transmit a signal to the new electronic device to power down.

In some embodiments, the remote control, in response to successfully connecting to a new electronic device, may cause the new electronic device to perform other functions. For example, the remote control may cause the newly connected electronic device to raise or lower its volume, power off and power on, to power on, to display a specific screen or image, and so on. Once the other function is learned, the electronic device is powered down to indicate to the user that the new function has been learned.

In some embodiments, the remote control console may receive the configuration data via input components of the remote control. That is, the remote control may utilize the learning function component 246 as a verification component that verifies all new equipment using routine 400, regardless of how the remote control receives the configuration data for an electronic device to be added to the remote control.

Thus the powering down and other indicators may indicate to a user the successful learning of the commands or codes of the new electronic device, reducing the confusion caused during setup of a new electronic device to be controlled by the remote control, among other benefits.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of examples of the system is not intended to be exhaustive or to limit the system to the precise form disclosed above. While specific examples of, and examples for, the system are described above for illustrative purposes, various equivalent modifications are possible within the scope of the system, as those skilled in the relevant art will recognize. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

While certain aspects of the system are presented below in certain claim forms, the inventors contemplate the various aspects of the system in any number of claim forms. For example, while only one aspect of the system is recited as a system, other aspects may likewise be recited as a system. Accordingly, the inventors reserve the right to add additional claims after filing the application to pursue such additional claim forms for other aspects of the system.

We claim:

1. A universal remote control, comprising:
a housing having a bottom and top portion;
a keypad located in the top portion of the housing and configured to receive input from a user of the remote control;
a signal component located with the housing and configured to transmit a signal in response to input received by the keypad;
a backlight component located within the housing and configured to backlight the keypad;
a backlight control component located within the housing and configured to cause the backlight component to emit a predetermined color for the backlight based on a mode of operation of the universal remote control.

2. The universal remote control of claim 1, wherein the backlight control is configured to cause the backlight component to emit a different color than the predetermine color for the backlight in response to a changed mode of operation of the universal remote control.

3. The universal remote control of claim 1, wherein the backlight control component is configured to receive instructions from a data structure stored within memory of the universal remote control that relates backlight colors with modes of operation of the universal remote control.

4. The universal remote control of claim 1, further comprising:
a learning component located within the housing and configured to power down a piece of audiovisual equipment in response to a successful connection to the piece of audiovisual equipment.

5. A method for indicating a mode of operation of a remote control, the method comprising:
receiving an indication that the remote control is under a first mode of operation; and
backlighting an input button located within a housing of the remote control with a color associated with the first mode of operation.

6. The method of claim 5, further comprising:
receiving an indication that the remote control is under a second mode of operation; and
backlighting the input button located within the housing of the remote control with a color associated with the second mode of operation.

7. The method of claim 6, wherein the color associated with the second mode of operation is different than the color associated with the first mode of operation.

8. The method of claim 6, wherein the first mode of operation is associated with controlling a broadcasted media device and the second mode of operation is associated with controlling a recorded media device.

9. The method of claim 5, wherein backlighting the input button within the housing of the remote control includes backlighting all of the input buttons within the housing of the remote control.

10. The method of claim 5, wherein backlighting the input button within the housing of the remote control includes backlighting the input buttons within the housing of the remote control capable of being utilized to receive input from a user during the first mode of operation.

11. The method of claim 5, wherein the backlit input button is only utilized during the first mode of operation, the method further comprising:
backlighting a different input button with a color associated with multiple modes of operation of the remote control.

12. The method of claim 5, wherein the color associated with the first mode of operation was assigned to the mode of operation by a user of the remote control.

13. A system for verifying a learning function of a universal remote control, the system comprising:
a data component that is configured to receiving configuration data associated with a piece of audiovisual equipment to be controlled by the universal remote control;
an operation mode component that is configured to add a new mode of operation associated with the piece of audiovisual equipment for the universal remote control based on the received configuration data; and
a verification component that is configured to verify a successfully added mode of operation by causing a signal component of the universal remote control to power down the piece of audiovisual equipment.

14. The system of claim 13, further comprising:
a backlight component that is configured to backlight an input button located within a housing of the universal remote control with a color associated with the new mode of operation.

15. The system of claim 13, wherein the data component receives the configuration data from a user via a keypad located within a housing of the universal remote control.

16. The system of claim 13, wherein the data component receives the configuration data from another remote control previously associated with the piece of equipment.
